(19) United States
(12) Patent Application Publication
(10) Pub. No.: US 2008/0257281 A1
(43) Pub. Date: Oct. 23, 2008

(54) Water Heater and a Method of Operating Same

(75) Inventors: Philip Ross Pepper, New South Wales (AU); Roger Curth, New South Wales (AU); Steve Chick, New South Wales (AU); Brian Chertkow, New South Wales (AU)

Correspondence Address: FITCH EVEN TABIN AND FLANNERY, 120 SOUTH LA SALLE STREET, SUITE 1600, CHICAGO, IL, 60603-3406, US

(73) Assignee: ZIP INDUSTRIES (AUST) PTY LTD, NEW SOUTH WALES (AU)

(21) Appl. No.: 10/592,833

(22) PCT Filed: Mar. 1, 2005
(86) PCT No.: PCT/AU2005/000286

§ 371 Date: Jul. 11, 2008

(30) Foreign Application Priority Data
Mar. 15, 2004 (AU) 2004901343

(51) Int. Cl. F24H 9/20; G01K 1/00

(52) U.S. Cl. 122/14.1; 374/100

(57) ABSTRACT

A method of determining an operating water temperature for a boiling water heater includes the following steps: (a) adding water to a tank to a predetermined level; (b) heating the water in the tank to approximately 95 degrees Celsius; (c) applying sufficient heat to the water in the tanks so as to cause boiling of the water in the tank within a predetermined first period of time; (d) measuring the boiling water temperature of the water in the tank; and (e) subtracting a predetermined temperature from the boiling water temperature measured in step (d) to arrive at the operating water temperature.

### FIELD OF THE INVENTION

The present invention relates to a water heater and a method of operating same.

The invention has been primarily developed in relation to a boiling water heater and will be described hereinafter with reference to this application. However, it will be appreciated that the invention is not limited to this particular field of use and is also, for example, suitable for use in combined water heater and water chiller units.

### BACKGROUND OF THE INVENTION

In order to achieve maximum performance, water heaters should operate at a temperature very close to water's boiling point. However, water boils at different temperatures at different atmospheric pressures. This change is relatively minor for different atmospheric conditions at a given altitude, but becomes more significant when comparing operation at sea level versus operation at a high altitude above sea level.

As an example, a boiling water heater designed to operate at 1 or 2° C. below boiling point at sea level may operate in an over boil condition when taken to an elevated altitude. This situation is further complicated due to the inaccuracies of temperature measuring devices, particularly when attempting to control water temperature to within 1 or 2° C. of the boiling point. Hitherto, there have been a number of attempts to solve this problem.

One simple method has been to set the heater operating temperature below that at which water would boil at the highest expected altitude. However, this compromises the performance of the heater at lower altitudes, where the majority of sales occur.

Another more complex and costly approach is to provide the heater with a manual temperature adjustment that can be altered depending on location. However, in most cases, this will require adjustment by a skilled service technician and would not be able to be adjusted by the user. Further, whilst the adjustment may, in some instances, be carried out at the time of initial installation, the normal practice would be a follow up service call to adjust the settings for a user unhappy with performance. Disadvantages of this approach include the cost to the user for the service call and that, even after the adjustment, performance may still be compromised. The latter is due to the fact that any adjustment made by the service technician will be to an operating temperature closer to the correct boiling point, but still leaving sufficient temperature differential between the actual preferred operating temperature and boiling point to prevent any nuisance over boil occurring. Over boil can result in excess steam generation and/or nuisance tripping of the water heater power cut-out. In either case, a further service call is required to rectify the fault, which would result in most service technicians adjusting the heater to an operating temperature sufficiently low to prevent this condition arising. This again leads to compromised performance.

Boiling water heaters require less energy and operating time when compared to traditional kettles and urns. However, maintaining water at boiling temperature requires a constant energy input. In most instances, boiling water units are installed in commercial applications where the need for instant boiling water is limited to typical office hours. Notwithstanding that outside of those hours instant boiling water is not often required, boiling water units are either left on at full operating temperature or timers are installed to switch the heater off at pre-programmed times.

Whilst it is beneficial to switch off the heater during periods of prolonged non use, there are some disadvantages to this approach. Firstly, the resultant power saving is often less expensive than the cost of a programmable timer. Accordingly, whilst it may not be cost efficient to install a timer it is energy efficient from an environmental standpoint. Secondly, if boiling water in the tank is allowed to cool below about 45° C. then various forms of bacteria, including legionella, may grow. Bringing the water back to the boil will kill any bacteria, as long as the water is boiling before being drawn off by a user. Disadvantages of programmable timers include that someone needs to be taught to do the programming and, if for some reason boiling water is required outside of the pre-programmed hours, it may be difficult or complicated to bypass the timer.

Another disadvantage associated with known water heaters is that when the temperature control system recognises that a desired water temperature has been reached, it will shut off power to the heating element. However, hysteresis normally causes the residual heat in the element to provide some additional heating, which can result in over boiling and therefore energy wastage.

### OBJECT OF THE INVENTION

It is the object of the present invention to overcome or at least ameliorate one or more of the prior art disadvantages noted above.

### SUMMARY OF THE INVENTION

Accordingly, in a first aspect, the present invention provides a method of determining an operating water temperature for a boiling water heater, the method including the following steps:

(a) adding water to a tank to a predetermined level;

(b) heating the water in the tank to approximately 95 degrees Celsius;

(c) applying sufficient heat to the water in the tank so as to cause boiling of the water in the tank within a predetermined first period of time;

(d) measuring the boiling water temperature of the water in the tank; and

(e) subtracting a predetermined temperature from the boiling water temperature measured in step (d) to arrive at the operating water temperature.

The method preferably also includes the step of maintaining the water in the tank at approximately 95 degrees Celsius for a predetermined second period of time between steps (b) and (c).

The first and second predetermined periods of time are preferably approximately 90 and 120 seconds respectively.

The predetermined temperature subtracted in step (e) is preferably 1.5 degrees Celsius.

In a second aspect, the present invention provides a water heater adapted to determine an operating water temperature, the heater including:

a water tank;

means to measure the water temperature of the water in the tank;

a timer; and

heating means adapted to heat the water in the tank to approximately 95 degrees Celsius, the heating means also being adapted to apply sufficient heat to the water in the tank so as to cause boiling of the water in the tank within a predetermined first period of time,

wherein the operating water temperature of the water is the measured boiling water temperature minus a predetermined temperature.

The heating means is preferably also adapted to maintain the water in the tank at approximately 95 degrees Celsius for a predetermined second period of time, prior to the heating means applying sufficient heat to the water in the tank so as to cause boiling of the water in the tank within a predetermined first period of time.

The first and second predetermined periods of time are preferably approximately 90 and 120 seconds respectively.

The predetermined temperature subtracted is preferably 1.5 degrees Celsius.

The heater preferably also includes a controller adapted to control the heating means in response to input from the timer and/or the temperature measuring means.

In a third aspect, the present invention provides a method of operating a water heater, the method including the following steps:

(a) adding water to a tank to a predetermined level;

(b) monitoring the time period since water was last dispensed from the water tank; and

(c) if the monitored time period reaches a predetermined time, then removing water heating energy from the tank until the water in the tank cools to a predetermined temperature, above a temperature where bacterial growth can occur, and applying sufficient heat to the water in the tank so as to maintain the temperature of the water in the tank approximately at the predetermined temperature.

The predetermined temperature is preferably about 64 degrees Celsius.

The predetermined time period is preferably about 2 or 4 hours, most preferably at the user's option.

The method preferably also includes the step of returning the heater to full power operation upon sensing that water has been dispensed.

In a fourth aspect, the present invention a water heater including:

a water tank;

means to sense when water is dispensed from the tank;

a timer to monitor the time period since water was last dispensed from the water tank;

means to measure the temperature of the water in the tank; and

heating means to heat the water in the tank,

wherein, if the monitored time period reaches a predetermined time, energy is removed from the heating means until the water in the tank cools to a predetermined temperature which is above a temperature where bacterial growth can occur, and thereafter the heating means applies sufficient heat to the water in the tank so as to maintain the temperature of the water in the tank approximately at the predetermined temperature.

The predetermined temperature is preferably about 64 degrees Celsius.

The predetermined time period is preferably about 2 or 4 hours, most preferably at the user's option.

The heater is preferably adapted to return to full power operation upon sensing that water has been dispensed.

The heater preferably also includes a controller adapted to control the heating means in response to input from the timer and/or the sensing means and/or the temperature measuring means.

In a fifth aspect, the present invention provides a method of operating a water heater, the method including the following steps:

(a) adding water to a tank to a predetermined level;

(b) adding heat to the water at a first energy level until a first predetermined water temperature is reached;

(c) adding heat to the water at a second energy level, lower than the first energy level, until a second predetermined water temperature, higher than the first predetermined water temperature, is reached.

The method preferably also includes the step of adding heat to the water at a third energy level, lower than the second energy level, until a third predetermined water temperature, higher than the second predetermined water temperature, is reached.

The method preferably also includes the step of adding heat to the water at a fourth energy level, lower than the third energy level, until a fourth predetermined water temperature, higher than the third predetermined water temperature, is reached.

The first energy level is preferably the full power capacity of the water heater.

The first predetermined water temperature is preferably about 2 degrees Celsius below the water heater's desired operating temperature.

The second energy level is preferably about 50% of the full power capacity of the water heater.

The second predetermined water temperature is preferably about 1 degree Celsius below the water heater's desired operating temperature.

The third energy level is preferably about 25% of the full power capacity of the water heater.

The third predetermined water temperature is preferably about 0.5 degrees Celsius below the water heater's desired operating temperature.

The fourth energy level is preferably about 10% of the full power capacity of the water heater, and is preferably provided in pulses.

In a sixth aspect, the present invention provides a water heater including:

a water tank;

means to measure the temperature of the water in the tank; and

adjustable heating means adapted to add selectively variable heat to the water in the tank,

wherein the heating means operates at a first energy level until a first predetermined water temperature is reached whereafter the heating means operates at a second energy level, lower than the first energy level, until a second predetermined water temperature, higher than the first predetermined water temperature, is reached.

The heating means is preferably also adapted to operate at a third energy level, lower than the second energy level, until a third predetermined water temperature, higher than the second predetermined water temperature, is reached.

The heating means is preferably also adapted to operate at a fourth energy level, lower than the third energy level, until a fourth predetermined water temperature, higher than the third predetermined water temperature, is reached.

The first energy level is preferably the full power capacity of the water heater.

The first predetermined water temperature is preferably about 2 degrees Celsius below the water heater's desired operating temperature.

The second energy level is preferably about 50% of the full power capacity of the water heater.

The second predetermined water temperature is preferably about 1 degree Celsius below the water heater's desired operating temperature.

The third energy level is preferably about 25% of the full power capacity of the water heater.

The third predetermined water temperature is preferably about 0.5 degrees Celsius below the water heater's desired operating temperature.

The fourth energy level is preferably about 10% of the full power capacity of the water heater, and is preferably provided in pulses.

The heater preferably also includes a controller adapted to control the heating means in response to input from the temperature measuring means.

### BRIEF DESCRIPTION OF THE DRAWINGS

A preferred embodiment of the invention will now be described, by way of example only, with reference to the accompanying drawings in which:

FIG. 1 is a partial perspective view of an embodiment of a water heater according to the invention, during initial filling;

FIG. 2 is a partial perspective view of the heater shown in FIG. 1 during intermediate filling;

FIG. 3 is a partial perspective view of the heater shown in FIG. 1, when full;

FIG. 4 is a logic diagram associated with the operating temperature calibration of the heater shown in FIG. 1; and

FIG. 5 is a logic diagram associated with the sleep mode of the heater shown in FIG. 1.

### DETAILED DESCRIPTION OF THE PREFERRED EMBODIMENT

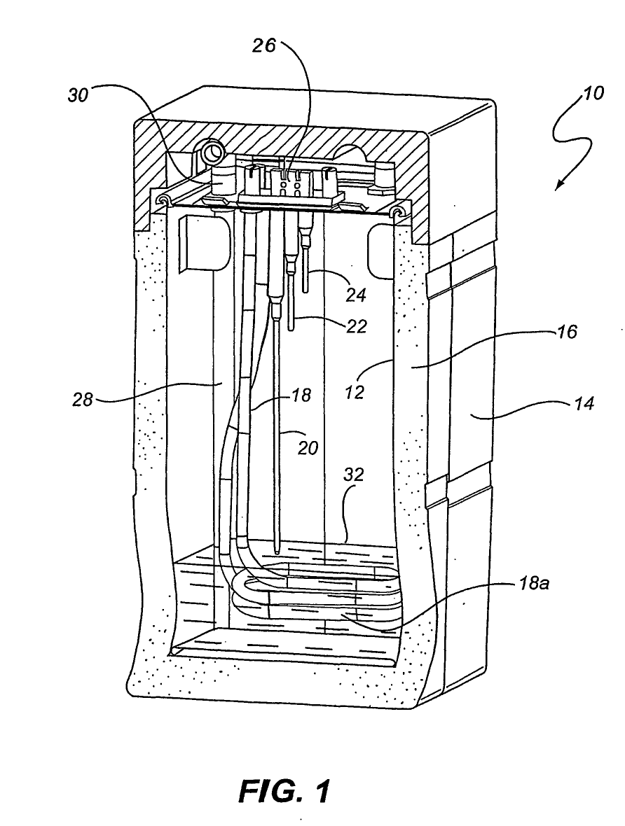

Referring to FIGS. 1 to 3 there is shown an embodiment of a boiling water heater 10 according to the present invention. The water heater 10 has a water tank 12, an outer casing 14 and insulation 16 therebetween. Inside the water tank 12, there is an electric heating element 18, which has a lower coiled end 18a, and first, second and third level sensors 20, 22 and 24 respectively. The water heater 10 also includes a mounting block 26 for the three level sensors 20, 22 and 24.

The heater 10 also has PCB controller (not shown) which is connected to the three level sensors 20, 22 and 24, a temperature sensor (not shown) within the tank 12, a timer and a number of other components. The controller can control the energy supply to the heating coil 18 in response to signals received from the three level sensors 20, 22 and 24 and the temperature sensor.

The water heater 10 also includes a water inlet pipe 28 with an inlet elbow 30. The elbow 30, and thus the pipe 28, is supplied with mains water through a solenoid operated inlet valve (not shown), which is also controlled by the controller. The water heater 10 also includes a solenoid operated outlet valve, which is also controlled by the controller, and outlet pipe, which are not shown in FIGS. 1 to 3 for clarity purposes.

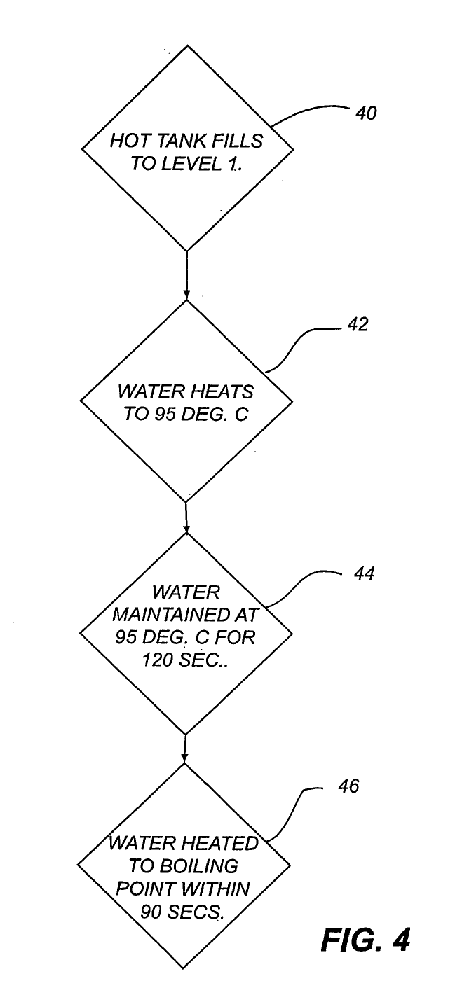

A method of determining an operating water temperature (i.e. calibrating) for the water heater 10 will now be described in conjunction with FIG. 4 which represents the basic steps 40, 42, 44 and 46 of the method.

The first step 40 of the method occurs after the heater 10 has been installed and comprises the tank 12 being filled with water 32 until the level reaches that of the first level sensor 20. This amount of the water 32 is sufficient to immerse the coiled end 18a of the heating element 18.

As indicated in step 42, the controller then energises the heating element 18 to heat the water to 95° C. and then, as indicated in step 44, maintain the water 32 at this temperature for a period of 120 seconds in order to saturate the tank 12 with heat.

As indicated in step 46, at the end of this saturation period the water 32 is then heated to boiling point in a 90 second time period and the controller 26 records the maximum water temperature reached. It is important to note that the heating element 18 can boil the water 32 prior to the completion of the 90 second period and that but the temperature of boiling water remains constant until all the water has boiled away.

At the end of the 90 second period the controller recalls the maximum temperature reached, which will be the boiling point for the atmospheric conditions where the heater 10 has been installed. The controller will then set the operating temperature or set point of the water heater 10 at 1.5 below the measured boiling point.

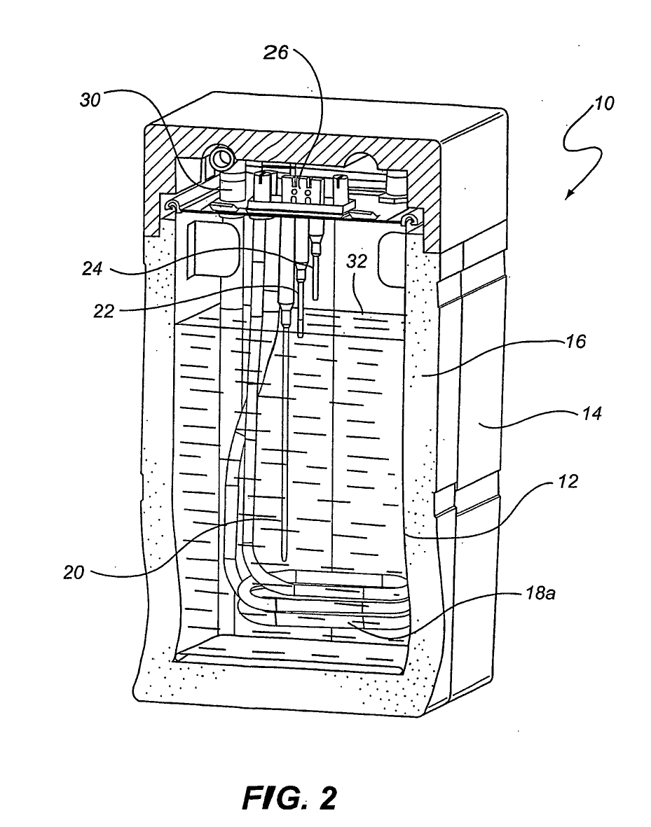

When this calibration process has taken place the water heater 10 will then continue to fill and heat up. More particularly, the controller will open the valve 32 and fill the tank 12 with water until it reaches the second water level sensor 24 (see FIG. 2) and at a controlled rate which will not allow the water 32 in the tank 12 to drop 2° C. below the set point temperature. When the water 30 reaches the set point temperature the inlet valve 32 opens and allows water to enter the tank 12 until such time as the temperature of the water drops 3° C. below the set point. If the water at any time drops to more than 3° C. below the set point the inlet valve 30 is closed and the heater 10 allowed to heat up to the set point temperature. During this filling period the controller energises the heating element to operate at 100% power.

There are numerous advantages arising from the above calibration method. Firstly, the performance from one heater to another is always consistent. Secondly, the exact accuracy of the temperature measuring device utilised in the heater is not critical, as long as the device is stable. Thirdly, the performance of the heater relative to actual boiling point is always consistent. Fourthly, the operating water temperature is always maintained extremely close to the actual boiling point as the actual boiling point is firstly determined by the heater. Fifthly, no compromises in performance are required to achieve optimum performance at different sites having different atmospheric conditions. Sixthly, no external adjustment is required to achieve optimum performance and no skilled service technician is required for optimum performance. The above advantages also lead to lower cost to the user, reduced energy consumption as over boil conditions are prevented and overall improved customer satisfaction.

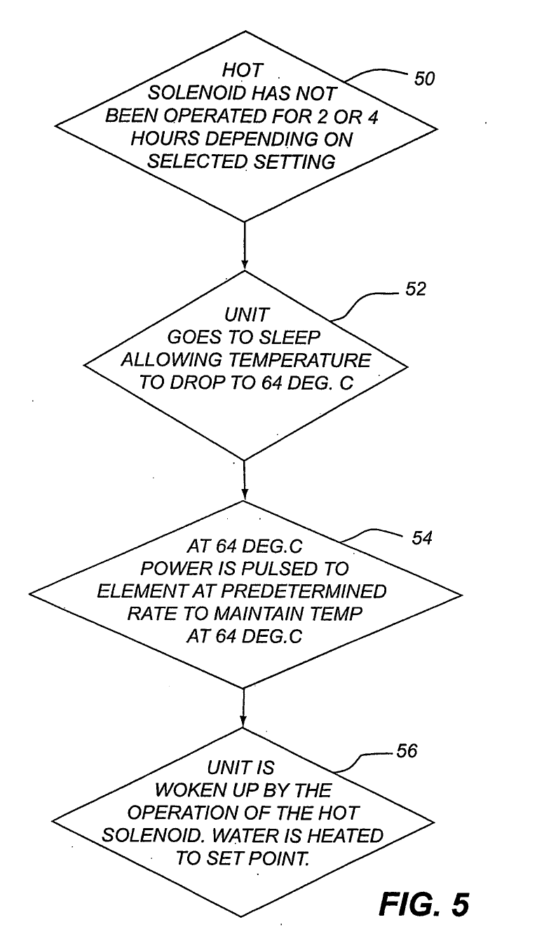

A method of operating the water heater 10 in an energy saving or sleep mode will now be described in conjunction with FIG. 5 which represents the basic steps 50, 52 and 54 of the method.

As indicated in step 50, during normal operation of the water heater 10 the controller monitors the length of time since the hot water outlet valve (not shown) has been activated. More particularly, the controller monitors whether the period of valve inactivity is 2 or 4 hours, depending on the setting selected.

As indicated in step 52, if the hot water outlet valve has not operated for the selected time, then energy is removed from the heating element 18 to place the water heater 10, to place it in an energy saving mode (sleep mode), until the temperature of the water in the tank 12 has fallen to about 64° C.

As indicated in step 54, once the water temperature has reached 64° C., power is pulsed to the element 18 at a rate sufficient to maintain the water temperature at about 64° C. However, and as indicated in step 56, if the hot water outlet valve is activated the sleep mode is cancelled and the element 18 is energised to bring the water 32 back up to its operating set point. Typically, the water 32 will reach the preferred operating temperature within about 2 to 3 minutes.

The advantages of the sleep mode described above are as follows. Firstly, no pre-programmed timer is required. Secondly, no external influence is required. Thirdly, the system is far more flexible for the user. Fourthly, energy savings are achieved with an impact on both energy cost and environmental greenhouse gases reductions. Lastly, health considerations are not compromised as the water is not allowed to cool to a temperature where bacteria growth may occur.

The heater 10 also has a general mode of operation which leads to increased energy savings as will be described below.

As stated earlier, when water is brought to boil, the temperature of the water remains constant whilst the water boils. Also, when the controller recognises that a desired temperature has been reached and shuts off power to the element, hysteresis normally causes the residual heat from the element to cause some over boiling and therefore energy wastage. This can be further complicated by the response time lag of the controller.

In the heater 10, the controller recognises when the temperature of the water is approaching the predetermined operating temperature and begins to reduce the energy applied to the element 18. Put another way, the closer the water 32 is to the boiling temperature the lower the energy input.

More particularly, when the tank 12 is filled to the second water level sensor 22 (see FIG. 2), the controller supplies full power to the element 18 until the water 32 in the tank 12 is heated to within 2° C. of the set point. At this point the power supplied to the element 18 is reduced to 50% of its maximum capacity. This prevents the heater 10 from venting excessive steam

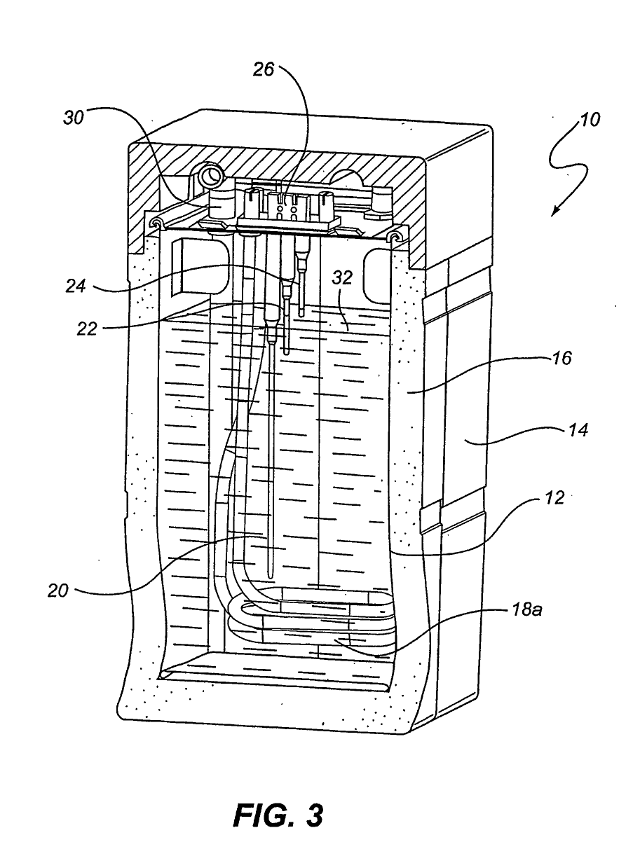

Further, when the tank 12 is filled to the third water level sensor 24 (see FIG. 3), the inlet valve is kept open for 20 seconds. This allows a slight overfilling of the tank 12 and prevents nuisance operating of the valve 32 due to evaporation or water turbulence. The element 18 is also set to operate at 25% of its maximum and maintained there until the set point temperature is reached. Finally, when the water temperature is within 0.5° C. of the set point the power supplied to the element 18 is reduced to 10% of its maximum capacity and supplied in pulses to maintain the water temperature at the set point.

The advantages arising from this are as follows. Firstly, the method provides more accurate temperature control at the operating condition. Secondly, the heater has reduced power consumption. The minimising of over boiling results in less steam generation, minimal resource wastage and a quieter running water heater.

Although the invention has been described with reference to a preferred embodiment, it would be appreciated by those skilled in the art that the invention may be embodied in many other forms.

1. A method of determining an operating water temperature for a boiling water heater, the method including the following steps:
(a) adding water to a tank to a predetermined level;
(b) heating the water in the tank to approximately 95 degrees Celsius;
(c) applying sufficient heat to the water in the tank so as to cause boiling of the water in the tank within a predetermined first period of time;
(d) measuring the boiling water temperature of the water in the tank; and
(e) subtracting a predetermined temperature from the boiling water temperature measured in step (d) to arrive at the operating water temperature.

2. The method is claimed in claim 1, and further including the step of maintaining the water in the tank at approximately 95 degrees Celsius for a predetermined second period of time between steps (b) and (c).

3. The method as claimed in claim 2, wherein the first and second predetermined periods of time are approximately 90 and 120 seconds respectively.

4. The method as claimed in claim 1, wherein the predetermined temperature subtracted in step (e) is 1.5 degrees Celsius.

5. A water heater adapted to determine an operating water temperature, the heater including:
a water tank;
means to measure the water temperature of the water in the tank;
a timer; and
heating means adapted to heat the water in the tank to approximately 95 degrees Celsius, the heating means also being adapted to apply sufficient heat to the water in the tank so as to cause boiling of the water in the tank within a predetermined first period of time, wherein the operating water temperature of the water is the measured boiling water temperature minus a predetermined temperature.

6. The water heater as claimed in claim 5, wherein the heating means is also adapted to maintain the water in the tank at approximately 95 degrees Celsius for a predetermined second period of time, prior to the heating means applying sufficient heat to the water in the tank to cause boiling of the water in the tank within the predetermined first period of time.

7. The water heater as claimed in claim 6, wherein the first and second predetermined periods of time are approximately 90 and 120 seconds respectively.

8. The water heater as claimed in claim 5, wherein the predetermined temperature subtracted is 1.5 degrees Celsius.

9. The water heater as claimed in claim 5, wherein the heater also includes a controller adapted to control the heating means in response to input from the timer and/or the temperature measuring means.

10. A method of operating a water heater, the method including the following steps:
(a) adding water to a tank to a predetermined level;
(b) monitoring the time period since water was last dispensed from the water tank; and
(c) if the monitored time period reaches a predetermined time, then removing water heating energy from the tank until the water in the tank cools to a predetermined temperature, above a temperature where bacterial growth can occur, and applying sufficient heat to the water in the tank so as to maintain the temperature of the water in the tank approximately at the predetermined temperature.

11. The method as claimed in claim 10, wherein the predetermined temperature is about 64 degrees Celsius.

12. The method as claimed in claim 10, wherein the predetermined time period is about 2 to 4 hours.

13. The method as claimed in claim 10, wherein the method also includes the step of returning the heater to full power operation upon sensing that water has been dispensed.

14. A water heater including:
a water tank;
means to sense when water is dispensed from the tank;
a timer to monitor the time period since water was last dispensed from the water tank;
means to measure the temperature of the water in the tank; and
heating means to heat the water in the tank,
wherein, if the monitored time period reaches a predetermined time, energy is removed from the heating means until the water in the tank cools to a predetermined temperature which is above a temperature where bacterial growth can occur, and thereafter the heating means applies sufficient heat to the water in the tank so as to maintain the temperature of the water in the tank approximately at the predetermined temperature.

15. The water heater is claimed in claim 14, wherein the predetermined temperature is about 64 degrees Celsius.

16. The method as claimed in claim 14, wherein the predetermined time period is about 2 to 4 hours.

17. The method as claimed in claim 14, wherein the heater is adapted to return to a full power operation upon sensing that water has been dispensed.

18. The method as claimed in claim 14, wherein the heater also includes a controller adapted to control the heating means in response to input from the timer and/or the sensing means and/or the temperature measuring means.

19. A method of operating a water heater, the method including the following steps:
(a) adding water to a tank to a predetermined level;
(b) adding heat to the water at a first energy level until a first predetermined water temperature is reached; and
(c) adding heat to the water at a second energy level, lower than the first energy level, until a second predetermined water temperature, higher than the first predetermined water temperature, is reached.

20. The method as claimed in claim 19, wherein the method also includes the step of adding heat to the water at a third energy level, lower than the second energy level, until a third predetermined water temperature, higher than the second predetermined water temperature, is reached.

21. The method as claimed in claim 20, wherein the method also includes the step of adding heat to the water at a fourth energy level, lower than the third energy level, until a fourth predetermined water temperature, higher than the third predetermined water temperature, is reached.

22. The method as claimed in claim 21, wherein the first energy level is a full power capacity of the water heater.

23. The method as claimed in claim 22, wherein the first predetermined water temperature is about 2 degrees Celsius below a desired water heater operating temperature.

24. The method as claimed in claim 23, wherein the second energy level is about 50% of the full power capacity of the water heater.

25. The method as claimed in claim 24, wherein the second predetermined water temperature is about 1 degree Celsius below the desired water heater operating temperature.

26. The method as claimed in claim 25, wherein the third energy level is about 25% of the full power capacity of the water heater.

27. The method as claimed in claim 26, wherein the third predetermined water temperature is about 0.5 degrees Celsius below the desired water heater operating temperature.

28. The method as claimed in claim 27, wherein the fourth energy level is about 10% of the full power capacity of the water heater.

29. The method as claimed in claim 28, wherein the fourth energy level is provided in pulses.

30. A water heater including:
a water tank;
means to measure the temperature of the water in the tank; and
adjustable heating means adapted to add selectively variable heat to the water in the tank,
wherein the heating means operates at a first energy level until a first predetermined water temperature is reached, whereafter the heating means operates at a second energy level, lower than the first energy level, until a second predetermined water temperature, higher than the first predetermined water temperature, is reached.

31. The water heater as claimed in claim 30, wherein the heating means is also adapted to operate at a third energy level, lower than the second energy level, until a third predetermined water temperature, higher than the second predetermined water temperature, is reached.

32. The water heater as claimed in claim 31, wherein the heating means is also adapted to operate at a fourth energy level, lower than the third energy level, until a fourth predetermined water temperature, higher than the third predetermined water temperature, is reached.

33. The water heater as claimed in claim 32, wherein the first energy level is a full power capacity of the water heater.

34. The water heater as claimed in claim 33, wherein the first predetermined water temperature is about 2 degrees Celsius below a desired water heater operating temperature.

35. The water heater as claimed in claim 34, wherein the second energy level is about 50% of the full power capacity of the water heater.

36. The water heater as claimed in claim 35, wherein the second predetermined water temperature is about 1 degree Celsius below the desired water heater operating temperature.

37. The water heater as claimed in claim 36, wherein the third energy level is about 25% of the full power capacity of the water heater.

38. The water heater as claimed in claim 37, wherein the third predetermined water temperature is about 0.5 degrees Celsius below the desired water heater operating temperature.

39. The water heater as claimed in claim 38, wherein the fourth energy level is about 10% of the full power capacity of the water heater.

40. The water heater as claimed in claim 39, wherein the fourth energy level is provided in pulses.

41. The water heater as claimed in claim 30, wherein the heater also includes a controller adapted to control the heating means in response to input from the temperature measuring means.
